(19) United States
(12) Patent Application Publication
(10) Pub. No.: US 2009/0290823 A1
(43) Pub. Date: Nov. 26, 2009

(54) Modular Unit for an Internal Combustion Engine

(76) Inventor: Wolfgang Issler, Schwaikheim (DE)

Correspondence Address: COLLARD & ROE, P.C., 1077 NORTHERN BOULEVARD, ROSLYN, NY, 11576, US

(21) Appl. No.: 11/990,045

(22) PCT Filed: Jul. 18, 2006
(86) PCT No.: PCT/DE2006/001237

§ 371 Date: Nov. 12, 2008

(30) Foreign Application Priority Data
Aug. 6, 2005 (DE) 10 2005 037 206.6

(51) Int. Cl. F16C 35/02

(52) U.S. Cl. 384/429

(57) ABSTRACT

The present invention relates to a modular unit for example for an internal combustion engine, having a shaft and having at least one further component, wherein the shaft is provided with bearing pins for mounting it in corresponding bearing bores provided in the at least one component. According to the invention, the surface of least one bearing pin has a sliding layer, with the surface of each bearing bore being in direct contact with the sliding layer of the associated bearing pin. The present invention also relates to a shaft and a component for a modular unit of the type. The shaft according to the invention can, for example, be a crankshaft or a camshaft.

The present invention relates to a modular unit of an internal combustion engine, having a shaft and at least one additional component, whereby the shaft is provided with bearing pins for mounting it in corresponding bearing bores provided in the at least one component. Furthermore, a shaft as well as a component for such a modular unit are an object of the present invention.

Such a modular unit can be, for example, a crankshaft mounted in an engine housing, with the related connecting rods, or a camshaft mounted in an engine housing.

U.S. Pat. No. 6,020,025 A discloses a crankshaft mounted in an engine housing. The bearing pins of the crankshaft are provided with a hard nitride layer.

Furthermore, a camshaft is known from DD 294 317 A5, the cams of which are at least partly coated with a ceramic material.

In the automotive industry, there are increased efforts to reduce both weight and costs. The cited prior art does not offer any solutions for this.

The present invention is based on the task of making available a modular unit of the type mentioned above, which is designed in simpler manner and leads to weight and cost savings.

The solution consists of a modular unit having the characteristics of claim 1. According to the invention, it is provided that the surface of each bearing pin is provided with an anti-friction layer, and that the surface of each bearing bore stands in direct contact with the anti-friction layer of the related bearing pin. A shaft having the characteristics of claim 7 and a component having the characteristics of claim 11 also belong to the present invention.

By means of the configuration of the modular unit and the component according to the invention, the bearing shells that were previously necessary in the bearing bores of the component that correspond with the bearing pins are eliminated. This leads not only to a significant simplification in design, but also to significant weight savings. These weight savings result not only from the elimination of the bearing shells, but also from the circumstance that the configuration according to the invention allows a reduction in size of the bearing bores, at least by the wall thickness of the anti-friction bearing shells that have been eliminated, and thus of the outside circumference of the corresponding component. The elimination of the bearing shells is also accompanied by cost savings (assembly, inventory, multiplicity of parts). For example, a modular unit composed of a crankshaft and related connecting rods can be designed in such a manner that the connecting rods are smaller and lighter than before. This also has a positive effect on the dynamic behavior, in the case of mass acceleration during operation of the internal combustion engine. Accordingly, the bearing bores provided in the engine housing for a crankshaft or a camshaft can also be configured to be smaller, and the components can therefore also be configured to be reduced in mass.

Coating of the bearing pins, in each instance, with the anti-friction layer can be carried out in a clamping device, so that production of the shaft according to the invention can be carried out in technically and economically practical manner.

Depending on the individual areas of application, all the tribological layers known to a person skilled in the art are suitable as an anti-friction layer. The anti-friction layer can be sprayed on, jet-blasted on, rolled on, applied using a screen-printing process, or using galvanic methods. PVD or CVD layers are also suitable.

Advantageous further developments are evident from the dependent claims.

The surface of each bearing pin can be provided with the anti-friction layer, in whole or in part. The anti-friction layer can be, in particular, a ceramic, metallic, or plastic layer.

It is advantageous if the surfaces of the bearing bores have a low roughness, possibly also a targeted structuring, in order to further improve the tribological properties of the system of anti-friction layer/bearing bore. Also, the bearing bores can have an ovality produced in targeted manner, or local differences in diameter. Finishing of the bore surfaces can take place by means of honing, for example.

An exemplary embodiment of the invention will be explained in further detail below.

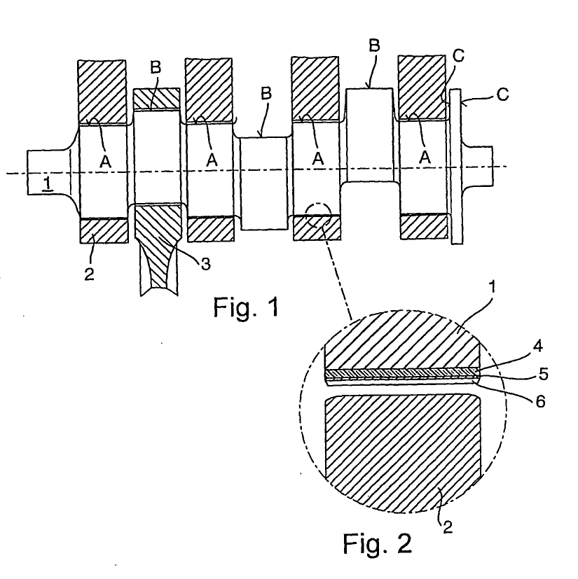

FIG. 1 shows a crankshaft 1 for an internal combustion engine, which is mounted in bearing points 2 that are fixed on the housing. Connecting rods 3 are disposed on shaft journals disposed eccentrically. The bearing points A of the shaft in the housing, the bearing points B for the connecting rods, and also the bearing point C for supporting axial forces, carry a functional coating, according to the invention, which particularly guarantees sufficient emergency running properties during the lack of lubrication that occurs when the engine is started, and thus prevents seizing of the parts, and which demonstrates sufficient ductility to be able to embed friction-wear or dirt particles that might be present in the oil stream, so that these do not lead to seizing and total failure of the bearing.

The coating fixed on the shaft, at the said bearing-points A, B, and C, can be structured, in the simplest case, of the same material, or with the same multi-layer structure—metallic or polymer overlay 6, possibly separated from the anti-friction bearing material by means of an intermediate layer, as shown in FIG. 2—but it is fundamentally also possible to apply different coatings having different properties, in each instance, such as strength, ductility, etc., in accordance with the different stresses at individual bearing points. In order to avoid unilateral edge pressure, the geometry of the shaft journals before coating, or vice versa, the bore in the assigned bearing point, can be configured to be slightly spherical.

### REFERENCE SYMBOLS

1 crankshaft
2 shaft bearing
3 connecting rod
4 anti-friction bearing material
5 intermediate layer
6 running layer
A, B, C bearing points

1. Modular unit of a movement mechanism, particularly of an internal combustion engine, having a shaft and at least one additional component, whereby the shaft is provided with bearing pins for mounting it in corresponding bearing bores provided in the at least one component, wherein the surface of at least one bearing pin is provided with an anti-friction layer, and that the surface of the related bearing bore stands in direct contact with this anti-friction layer.

2. Modular unit according to claim 1, wherein the surface of at least one bearing pin is partly provided with an anti-friction layer.

3. Modular unit according to claim 1, wherein the surface of at least one bearing pin is provided with an anti-friction layer over its full circumference.

4. Modular unit according to claim 1, wherein the anti-friction layer is a ceramic, metallic, or plastic layer, or is built up of multiple layers.

5. Modular unit according to claim 1, wherein the surface of the related bearing bore has a low roughness.

6. Modular unit according to claim 1, wherein the bearing bores have a non-round geometry that deviates from the cylindrical shape in targeted manner.

7. Shaft for a modular unit according to claim 1 provided with bearing pins for mounting it in corresponding bearing bores in at least one additional component that is provided, wherein the surface of at least one bearing pin is provided with an anti-friction layer.

8. Shaft according to claim 7, wherein the surface of at least one bearing pin is partly provided with an anti-friction layer.

9. Shaft according to claim 7, wherein the surface of at least one bearing pin is provided with an anti-friction layer over its full circumference.

10. Shaft according to claim 7, wherein the anti-friction layer is a ceramic, metallic, or plastic layer.

11. Component for a modular unit having at least one bearing bore for accommodating a corresponding bearing pin of a shaft according to claim 7, wherein the surface of the bearing bore has a low roughness.

12. Component according to claim 11, wherein the at least one bearing bore has a geometry that deviates from the cylindrical shape in targeted manner.

13. Component according to claim 1, wherein stop faces are provided on the shaft, to absorb axial forces, which have a one-layer or multi-layer coating as an anti-friction layer.

14. Component having a shaft according to claim 1, wherein at least one bearing bore also has a coating.

15. Component having a shaft according to claim 1, wherein at least one bearing point on the shaft has a spherical contour at least in partial regions.

16. Component having a shaft according to claim 1, wherein at least one bearing bore has a spherical contour at least in partial regions.

17. Component having a shaft according to claim 1, wherein stop faces are provided on the shaft, to absorb axial forces, which also have a one-layer or multi-layer coating as an anti-friction layer.

18. Component having a shaft, wherein stop faces are provided on the shaft, to absorb axial forces, which have a one-layer or multi-layer coating as an anti-friction layer, while the bearing points of the shaft journals remain uncoated.
